(19) United States
(12) Patent Application Publication
(10) Pub. No.: US 2009/0210182 A1
(43) Pub. Date: Aug. 20, 2009

(54) OPACITY OPTIMISATION FOR PAINT TOPCOAT/UNDERCOAT COMBINATION

(75) Inventor: Peter Laurence McGinley, Victoria (AU)

Correspondence Address: KNOBBE MARTENS OLSON & BEAR LLP, 2040 MAIN STREET, FOURTEENTH FLOOR, IRVINE, CA, 92614, US

(73) Assignee: ORICA AUSTRALIA PTY LTD, Melbourne, Victoria (AU)

(21) Appl. No.: 11/817,313

(22) PCT Filed: Feb. 27, 2006
(86) PCT No.: PCT/AU2006/000248

§ 371 Date: Aug. 8, 2008

(30) Foreign Application Priority Data
Feb. 28, 2005 (AU) 2005900941

(51) Int. Cl. G06F 19/00; G01N 21/55

(52) U.S. Cl. 702/81; 356/445

(57) ABSTRACT

An opacity process for paint, including generating paint color data representing a paint color, based on the scatter and absorption data, or reflectance data, for the paint color, generating, based on the paint color data, full hiding color data representing the reflectance of the paint color at full hiding, generating, for a plurality of undercoat paints with different reflectance levels, color combination data representing the color of at least one coat of the paint color and one of the undercoat paints, respectively, and generating color difference data representing opacity, based on a difference between the full hiding color data and the color data combination.

### FIELD

The present invention relates to an opacity process and system for paint, and in particular, to an opacity optimization process for paint.

### BACKGROUND

It is difficult, and often impractical, to apply paint in uniform thickness over a surface. Typically, a final layer of paint (or topcoat) is applied to a surface over a number of sections. This results in overlapping layers of paint, which gives rise to color inconsistencies where the paint thickness is non-uniform. For example, applying overlapping coats of topcoat of a poor-hiding color over a white colored substrate results in non-uniform paint thickness which creates a non-uniform (e.g. striped) color appearance. If the topcoat is applied evenly (e.g. as a single continuous coat) over a surface, the paint thickness will be uniform and color inconsistency is minimised. The color of the substrate and topcoat thickness both contribute to the final color of the topcoat. To correct any non-uniform color appearance, several coats of topcoat may be required.

The non-uniform color problem can be minimised by first applying a tinted undercoat having the most appropriate reflectance properties for a chosen topcoat color, and then applying one or more coats of topcoat over the undercoat. This enables color uniformity to be achieved with fewer coats of topcoat. The undercoat is ideally made from a base color corresponding to the full hiding color of the topcoat, but such an undercoat will rarely have an acceptable level of hiding power. A compromise is to tint a white undercoat to a range of shades of grey by adding different concentrations of black colorants to the undercoat. Each different shade of grey of the undercoat provides different reflectance properties. Undercoats made from such combinations of black and white colorants generally have very good hiding properties.

A topcoat is normally applied onto a white colored substrate, or onto a surface prepared with a white colored undercoat. It would therefore be practical to tint a white colored undercoat with different levels of grey or black to achieve the desired reflectance properties. However, selection of a suitable undercoat base color and determining the optimal tint for the undercoat to have the best reflectance properties for a chosen topcoat has been a complex and time-consuming process. There has also been no simple way to assess whether the benefit obtained in using a particular tinted undercoat to achieve satisfactory topcoat colors is justified by the additional specification required.

It is therefore desired to provide a process and system that addresses the above or at least provides a useful alternative.

### SUMMARY OF CERTAIN INVENTIVE ASPECTS

According to the present invention, there is provided an opacity process for paint, including:
i) generating paint color data representing a paint color, based on the scatter and absorption data, or reflectance data, for said paint color;
ii) generating, based on said paint color data, full hiding color data representing the reflectance of said paint color at full hiding;
iii) generating, for a plurality of undercoat paints with different reflectance levels, color combination data representing the color of at least one coat of said paint color and one of said undercoat paints, respectively; and
iv) generating color difference data representing opacity, based on a difference between said full hiding color data and said color data combination

The present invention also provides an opacity system for paint, including:
i) a paint color generator for generating paint color data representing a paint color, based on the scatter and absorption data, or reflectance data, for said paint color;
ii) a full hiding color generator for generating, based on said paint color data, full hiding color data representing the reflectance of said paint color at full hiding;
iii) a color combination generator for generating, for a plurality of undercoat paints with different reflectance levels, color combination data representing the color of at least one coat of said paint color and one of said undercoat paints, respectively; and
iv) a color difference generator for generating color difference data representing opacity, based on a difference between said full hiding color data and said color combination data.

### BRIEF DESCRIPTION OF THE DRAWINGS

A preferred embodiment of the present invention is herein described, by way of example only, with reference to the accompanying drawings, wherein:

FIG. 1 is a block diagram of an opacity optimization system;

FIG. 2 is a diagram of a table in a database of the opacity optimization system;

FIG. 3 is a flow chart of an opacity optimization process performed by the system;

FIGS. 4 and 5 are diagrams of graphical analysis displays produced by the system; and

FIGS. 6 and 7 are diagrams of lines of best fit displays produced by the system.

### DETAILED DESCRIPTION OF CERTAIN INVENTIVE EMBODIMENTS

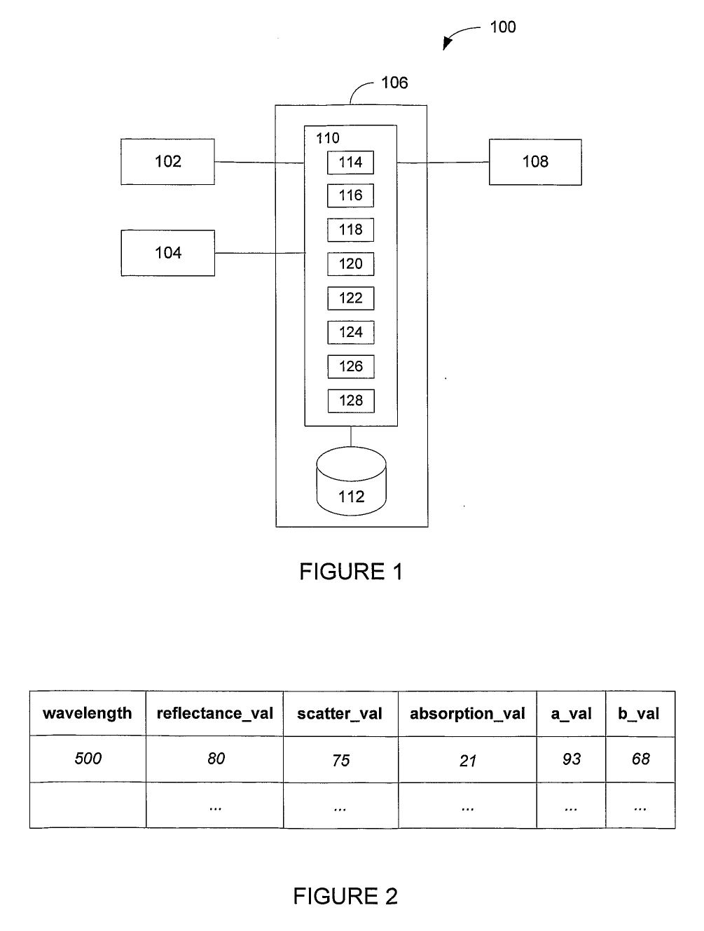

An opacity optimization system 100, as shown in FIG. 1, includes one or more input devices 102 and 104, a processing system 106, and an output device 108. Input devices 102 and 104 include hardware and software components that enable a user to obtain and/or provide input color data relating to a particular color (e.g. for a topcoat). An input device (e.g. 102 or 104) receives input color data by measurement or from data entered by a user, and each input device 102 and 104 interacts with a user interface generated by the processing system 106. The processing system 106 receives data from an input device 102 or 104, and generates output data for the output device 108. The output device 108 includes a visual display unit and a printer. The processing system 106 includes an opacity optimization module 110 and a database 112. The optimization module 110 is provided by computer program code in languages such as Java (http://www.java.sun.com) and Perl (http://www.perl.org), and the database 112 by a database server such as MySQL4 (http://www.mysql.org), all of which are executed on a standard personal computer (such as that provided by IBM Corporation <http://www.ibm.com>) running a standard operating system, such as Windows or Unix. Those skilled in the art will also appreciate the processes performed by the module 110 and the server 112 can also be executed at least in part by dedicated hardware circuits, e.g., Application Specific Integrated Circuits (ASICs) or Field-Programmable Gate Arrays (FPGAs). The optimization module 110 includes components 114, 116, 118, 120, 122, 124, 126 and 128, as discussed below, for performing an opacity process 200 of the system 100.

The optimization system 106 interfaces with a measurement-based input device 104 to take reflectance measurements for a coat of paint (e.g. a topcoat) of known thickness. The input device 104 includes a spectrophotometer with a diffuse/0 integrating sphere (ie diffuse illumination and light collection at the normal to the sample surface) or with a 45/0 optical geometry (i.e. illumination at 45 degrees and light collection at the normal to the sample surface). The system 106 can interface with commercially available spectrophotometers, such as the Gretag-Macbeth Color-Eye 7000A, the Datacolor 650 (or one from the Datacolor DF series, available from Datacolor International <http://www.datacolor.com/>), or any spectrophotometer from the X-Rite <http://www.xrite.com/> range.

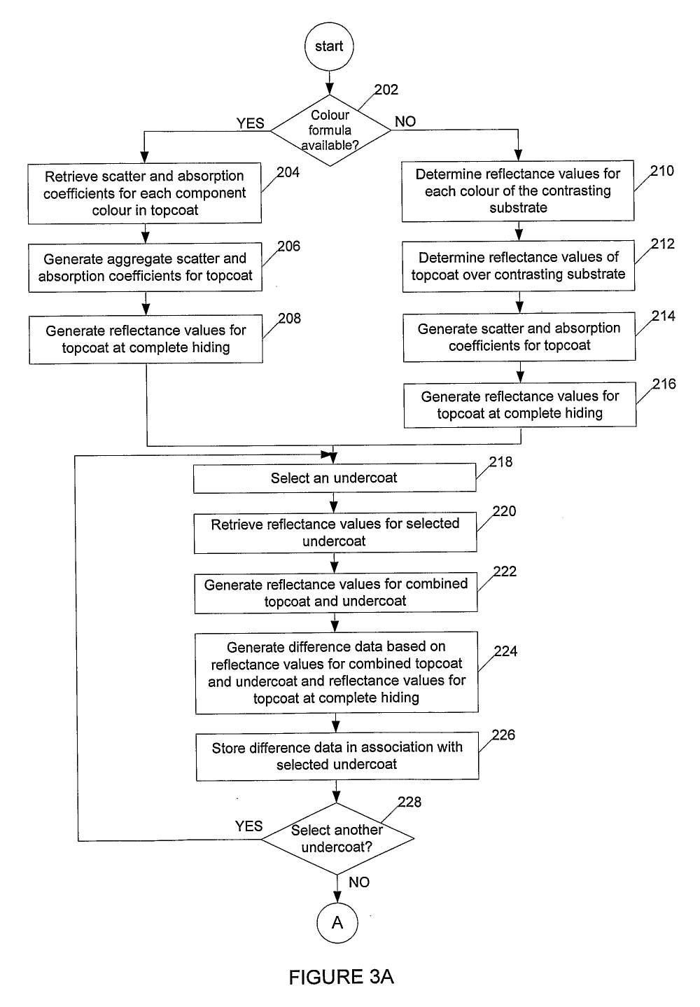

Input color data includes a set of reflectance data for a single color obtained by measurement (eg using the measurement-based input device 104). Reflectance data includes a set of values representing the degree of reflectance, for a coat of paint of known thickness, at different wavelengths (eg of visible light) over a predetermined range. Reflectance of paint is measured at different wavelengths of electromagnetic radiation, such as visible light. A wavelength measuring point refers to each specific wavelength at which reflectance is measured. The measured reflectance value is stored in a table in the database 112 (see FIG. 2) wherein the measured reflectance value is associated with the wavelength at which the measurement was taken. Measurements are made at consistent 5 nm, 10 nm or 20 nm intervals from adjacent wavelength measurement points, and the measurements are taken over a predetermined range of wavelengths (eg from 400 nm to 700 nm inclusive, or the preferred range from 380 nm to 780 nm inclusive). Color data can be generated using the reflectance data according to the method described by the International Commission on Illumination (CIE) (<http://www.cie.co.at>) in Publication 15, entitled “Colorimetry”, ISBN 3 901 906 33 9, (herein referred to as “CIE 15”).

The optimization system 106 also interfaces with a data entry input device 102, such as a mouse and/or keyboard, to enable a user to provide input color data that defines a color (eg a topcoat color). The input color data represents a color formula. A user enters a color formula by keying values into a textbox and/or selects predetermined values from a drop-down menu or list. For example, a user enters/selects an identifier corresponding to a single topcoat color (eg a unique numeric or text identifier, or a name—such as “Navy Blue”) from a drop-down menu or list. The selected identifier is used to retrieve a set of pre-measured reflectance data, and/or a set of pre-generated Kubelka Munk scatter and absorption coefficients, from the database 112 (eg by executing a Sequel (SQL) query). The Kubelka Munk theory is further described in D. B. Judd and G. Wyszecki, “Color in Business, Science and Industry”, 3rd ed., Wiley, New York, 1975 (herein referred to as “Judd and Wyszecki”). Alternatively, a user inputs a color formula by entering/selecting one or more identifiers (eg a unique numeric or text identifier, or name—as described above) corresponding to different component colorants in the topcoat, and also entering/selecting the concentration of each colorant. The identifier for each colorant is used to retrieve a set of pre-measured reflectance data, and/or a set of pre-generated Kubelka Munk scatter and absorption coefficients, from the database 112. An identifier corresponding to a topcoat color can be used to retrieve (eg from the database 112) a set of one or more other identifiers corresponding to the different colorants in the topcoat, and the concentration values for the different colorants.

The opacity optimization module 110 receives input color data corresponding to a topcoat color from the input device 102 or 104, and processes the input color data to generate opacity optimization data for the specified topcoat color. Opacity optimization data is then displayed using output device 108. Opacity optimization data includes:
(i) Undercoat reflectance data, which enables determination of optimal reflectance of the undercoat to achieve a minimal color difference between predefined coats of topcoat with the topcoat's full hiding color;
(ii) Tint concentration data, which defines the respective concentrations of a predefined black colorant for inclusion with a white undercoat to achieve a range of tinted undercoats with varying reflectance; and
(iii) Color effectiveness data, which defines (a) whether the undercoat with optimal reflectance (ie. the optimum undercoat) improves topcoat opacity such that satisfactory topcoat hiding is achieved within predetermined coats of topcoat; (b) whether satisfactory topcoat hiding is achieved by applying additional coats of topcoat without using an undercoat; and (c) whether the undercoat with optimal reflectance is unsuitable for improving topcoat opacity.

The optimization module 110 communicates with the database 112 (eg using the Sequel (SQL) language) to retrieve or insert data. The database 112 includes an array or matrix, a relational database, one or more structured data files (eg a comma or symbol delimited file, or an Extensible Markup Language (XML)), or one or more spreadsheets (eg a spreadsheet prepared using Microsoft Excel). FIG. 2 shows a table 150 in the database 112 for storing data corresponding to a single color (eg a set of reflectance data, scatter coefficient data and absorption coefficient data for a topcoat color or a component colorant of the topcoat). Table 150 stores at least a wavelength value 152 (shown as “wavelength”) and a corresponding reflectance value 154 (shown as “reflectance_val”). Table 150 associates each wavelength 152 with a corresponding scatter coefficient value 156 (shown as “scatter_val”) and absorption coefficient value 158 (shown as “absorption_val”) determined at that wavelength 152.

Reflectance values 154 in table 150 may be pre-measured at each wavelength 152 (which correspond to different wavelength measuring points), and the scatter 156 and absorption 158 coefficient values may be generated based on the reflectance value 154 corresponding to each wavelength 152 and stored in the database 112. The generation of scatter and absorption coefficients from reflectance values is described in Judd and Wyszecki. Each wavelength 152 in table 150 may be associated with a single reflectance value 154, or a scatter 156 and an absorption 158 coefficient value, or all three values together. Table 150 also associates a particular wavelength 152 with values for “a” and “b” coefficients 160 and 162 (shown as “a_val” and “b_val” respectively) determined at that wavelength 152. The “a” and “b” coefficients are values generated in intermediate steps in the process of determining scatter and absorption coefficients. As described below, the “a” coefficient includes the values of a and a′ generated on the basis of Equations 4 and 3A respectively, and the “b” coefficient includes the values of b and b′ generated on the basis of Equations 5 and 3B respectively.

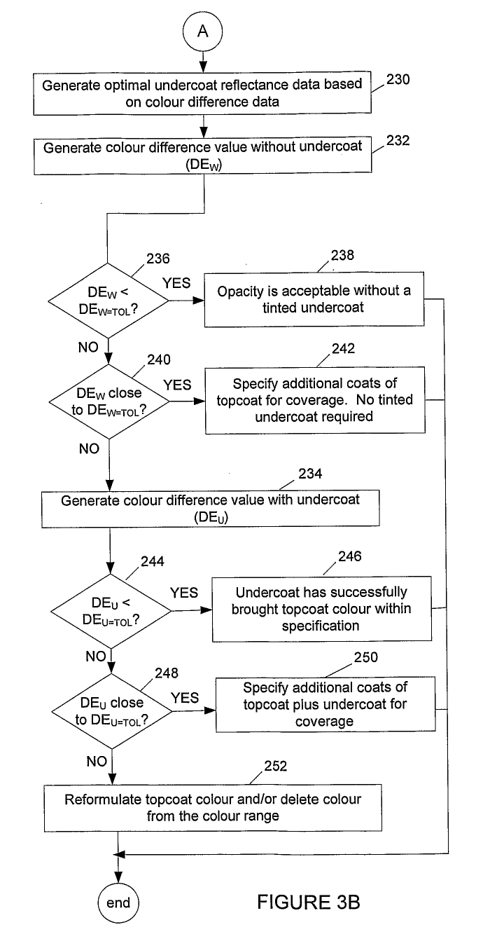

A flowchart of a process 200 for optimizing the opacity of topcoat paint, as shown in FIGS. 3A and 3B, is performed under the control of the opacity optimization module 110. Process 200 begins at step 202. A paint color generator component 114 of the module 110 handles communication with the input devices 102, 104 to store the data values in the table 150 and controls performances of steps 202, 204, 206, 210, 212 and 214. If step 202 determines that the input color data received from the input device 102 or 104 includes a color formula, the process 200 proceeds to step 204.

Input color data relates to a topcoat color, which may be made up of a combination of one or more different colorants at different concentrations. For decorative paint systems, a color formula defines a topcoat color in terms of a tint base and the respective concentrations of other different tinting colors. The tint base and tinting colors may be referred to as the component colorants for a topcoat. Each component colorant in the color formula may be characterised in terms of scatter and absorption coefficients for all wavelengths over a predefined range, as described above. At step 204, each component colorant in the color formula is identified, and a corresponding set of scatter (Sᵢ) and absorption (Kᵢ) coefficient values (ie corresponding to each wavelength 152 in table 150) are retrieved from different tables of the database 112 corresponding to each component colorant (eg based on the unique identifier for each colorant), where i represents the i-th colorant in the color mixture.

Based on the component colors in the color formula and their relative concentrations, the aggregate scatter (Sₘᵢₓₜᵤᵣₑ) and absorption (Kₘᵢₓₜᵤᵣₑ) coefficients for the topcoat are generated. Step 206 generates the aggregate absorption (Kₘᵢₓₜᵤᵣₑ) and scatter (Sₘᵢₓₜᵤᵣₑ) coefficients for the topcoat color using Equations 1 and 2 respectively (for each wavelength 152) by adding the scatter Sᵢ and absorption Kᵢ coefficients for each component colorant according to their respective concentrations Cᵢ:

Kₘᵢₓₜᵤᵣₑ=ΣCᵢKᵢ Equation 1

Sₘᵢₓₜᵤᵣₑ=ΣCᵢSᵢ Equation 2

A full hiding color generator component 116 of the module 110 generates, at step 208, a set of reflectance data values (R′_{∞}) of the topcoat at complete hiding (ie where each wavelength 152 has a corresponding reflectance value) using Equation 3:

$${R}_{∞}^{′} = 1 + \frac{{K}_{mixture}}{{S}_{mixture}} - \sqrt{{( \frac{{K}_{mixture}}{{S}_{mixture}} )}^{2} + 2 ( \frac{{K}_{mixture}}{{S}_{mixture}} )} \qquad Equation 3$$

A topcoat may not be completely opaque, which gives rise to color inconsistencies when additional coats of topcoat are applied one over another. The topcoat at complete hiding refers to the color of the topcoat when sufficient coats of topcoat are applied to make it completely opaque (ie no further color inconsistencies arise by applying further coats of topcoat). The set of reflectance values (R′_{∞}) refers to the predicted reflectance at each wavelength 152, based on the aggregate absorption (Kₘᵢₓₜᵤᵣₑ) and scatter (Sₘᵢₓₜᵤᵣₑ) coefficient values for each wavelength 152, for a topcoat at complete hiding.

Furthermore, at step 208, the full hiding color generator 116 generates the data values for the a′ and b′ coefficients using equations 3A and 3B below:

$$\begin{matrix}{a}^{′} = ( \frac{1}{{R}_{∞}^{′}} + {R}_{∞}^{′} ) / 2 & Equation 3 A \\ {b}^{′} = \sqrt{{( {a}^{′} )}^{2} - 1} & Equation 3 B\end{matrix}$$

The values generated using Equations 1, 2, 3, 3A and 3B are stored in a table in the database 112 corresponding to the topcoat color. For example, the value of R′₂₈, Kₘᵢₓₜᵤᵣₑ, Sₘᵢₓₜᵤᵣₑ, a′ and b′ at each wavelength is stored in the reflectance value 154, scatter coefficient value 156, absorption coefficient value 158, “a” coefficient value 160 and “b” coefficient value 162 fields of a table 150 respectively, and the value in these fields 154, 156, 158, 160 and 162 are associated with a corresponding wavelength value 152.

If step 202 determines that the input color data does not correspond to a color formula, the composition of the paint mixture is not known, and process 200 proceeds to step 210. Without a color formula, the set of scatter and absorption coefficient values for the topcoat are generated by the paint color generator 112 using reflectance data measured of the topcoat film (of known thickness and incomplete hiding, ie the substrate can be seen) over contrasting substrates of known reflectance.

The contrasting substrates could be the red and grey colors which are often used in the automotive industry to replicate the color of primer and undercoats on car bodies. For the system 106, black and white contrasting substrates are used (eg in the form of cardboard opacity charts or ceramic tiles, which are commonly used in the paint industry for visual opacity assessment). One half of a tile or surface (eg of approximately 6 inches×4 inches) is coated only in black, and the other half is coated only in white. At step 210, reflectance measurements are made (at each wavelength measuring point 152 over the predetermined range of wavelengths, as described above) of the black substrate and the white substrate separately. The reflectance measurements for the black substrate are stored as a set of reflectance data (R_{G=B}) in the database 112 (eg the measured values of wavelength reflectance are each associated, in the database, with the wavelength at which the measurement was taken). Similarly, reflectance measurements for the white substrate are stored as a set of reflectance data (R_{G=W}) in the database 112.

A uniform film of topcoat paint is then applied at incomplete hiding over the contrasting substrate (eg by spray application or using an appropriate draw down technique) such that the same film build or paint thickness exists over the black and white substrates. The thickness (T) of the topcoat applied over the contrasting substrate can be measured, or assumed (e.g. 1 coat of topcoat=62.5 microns wet film thickness when applied at the standard spreading rate of 16 m²/litre). At step 212, reflectance measurements are made (at each wavelength measuring point 152 over the predetermined range of wavelengths, as described above) of the partially hiding topcoat (usually a single coat) over the black substrate and white substrate separately. The reflectance measurements for the topcoat over the black substrate are stored as a set of reflectance data (R_{B}) in the database 112. Similarly, reflectance measurements for the topcoat over a white substrate are stored as a set of reflectance data (R_{W}) in the database 112.

At step 214, the paint color generator accesses the data values for R_{G=B}, R_{G=W}, R_{B}, R_{W} and T and uses Equations 4 and 5 below to generate values for a and b corresponding to the “a” and “b” coefficients respectively.

$$\begin{matrix}a = \frac{\begin{matrix}( {R}_{B} - {R}_{G = B} ) ( 1 + {R}_{W} {R}_{G = W} ) - \\ ( {R}_{W} - {R}_{G = W} ) ( 1 + {R}_{B} {R}_{G = B} )\end{matrix}}{2 ( {R}_{B} {R}_{G = W} - {R}_{W} {R}_{G = B} )} & Equation 4 \\ b = \sqrt{{a}^{2} - 1} & Equation 5\end{matrix}$$

Based on the value of the “a” and “b” coefficients at each wavelength 152 generated using Equations 4 and 5, step 214 generates a scatter coefficient value (S) using Equation 6, and an absorption coefficient value (K) using Equation 7:

$$\begin{matrix}S = \frac{1}{bT} ( Arctgh ( \frac{a - {R}_{B}}{b} ) - Arctgh ( \frac{a - {R}_{G = B}}{b} ) ) & Equation 6 \\ K = S ( a - 1 ) & Equation 7\end{matrix}$$

The full hiding color generator 116, at step 216, uses Equation 8 to generate the topcoat reflectance values at complete hiding (i.e. the true topcoat color that would be obtained if applied with sufficient number of coats to completely obliterate the substrate color).

R_{∞}=a−b Equation 8

Steps 208 and 216 both proceed to step 218. A color combination generator component 118 of the module 110 performs steps 218 to 222. At step 218, an undercoat is selected (eg by selecting an identifier for a tinted undercoat from a list of such identifiers). At step 220, a set of predetermined reflectance data corresponding to the selected undercoat identifier is retrieved from the database 112.

At step 222, Equation 9 is used to generate a set of predicted reflectance data (R) for the partially hiding coat of topcoat (of thickness T) when applied over the selected undercoat with known reflectance properties.

$$R = \frac{1 - {R}_{G = U} ( a - b . ctgh ( bST ) )}{a - {R}_{G = U} + b . cgth ( bST )} \qquad Equation 9$$

In Equation 9, R is a set of the predicted reflectance values for a topcoat (at each wavelength 152 over a predetermined range), T is the film thickness of the topcoat, and R_{G=U} is the reflectance of the undercoat being examined. If the color formula is known, the variables S, a, and b in Equation 9 are substituted with the values generated using Equations 2, 3A and 3B respectively. Reflectance data for the undercoat (R_{G=U}) may be pre-measured (similar to determining reflectance data for a topcoat, as described above) and stored in the database 112. Reflectance data for a range of undercoats (e.g. ranging from light to dark tints) may be stored in the database 112. An undercoat may be made up of more than one component color (e.g. an undercoat made from a base with the inclusion of other tint colorants), and the undercoat may be defined by a color formula. In this case the lightness and/or the hue of the undercoat may be varied (e.g. by adjusting any tint and/or its respective concentration value in the color formula) to find the optimum undercoat color.

A color difference generator component 120 of the module 110 performs steps 224 to 228. At step 224, the reflectance data for the topcoat and selected undercoat combination (over the predetermined wavelength range) is used to generate color data representing the color of the topcoat/undercoat combination (in accordance with CIE 15) for comparison against color data representing the full hiding color of the topcoat (generated from R_{∞}). Color data is generated based on the two sets of color data as Delta-E units to represent the color difference between the topcoat/undercoat combination and the full hiding color of the topcoat. The difference between two colors can be expressed in Delta-E units, where a Delta-E value of zero represents a perfect match and a large Delta-E value represents a poor color match. Generally, the color difference between two colors with a Delta-E difference of 1.0 would be visually perceivable, while colors with a Delta-E difference of 0.2 represents a good color match.

At step 226, the color difference data generated for the combined topcoat and selected undercoat is stored in the database 112 in association with the selected undercoat (eg such that the color difference data can be retrieved on the basis of the identifier for the selected undercoat).

Step 228 attempts to select another tinted undercoat for processing (eg by selecting any of the remaining undercoat identifiers from the list of such identifiers). If a different undercoat is selected, steps 218, 220, 222, 224 and 226 are repeated in respect of the newly selected undercoat. The color difference data generated in respect of each different topcoat/undercoat combination is stored in the database 112. A range of undercoats with different reflectance properties may be formulated for use with a particular topcoat. Normally the range of undercoat reflectance is achieved in a decorative paint tint system by adding increasing amounts of black tinter to a near white undercoat. In this way, undercoat reflectance values varying over a range (eg from 88% to 30%) can be delivered from one undercoat base and a series of tint formulas.

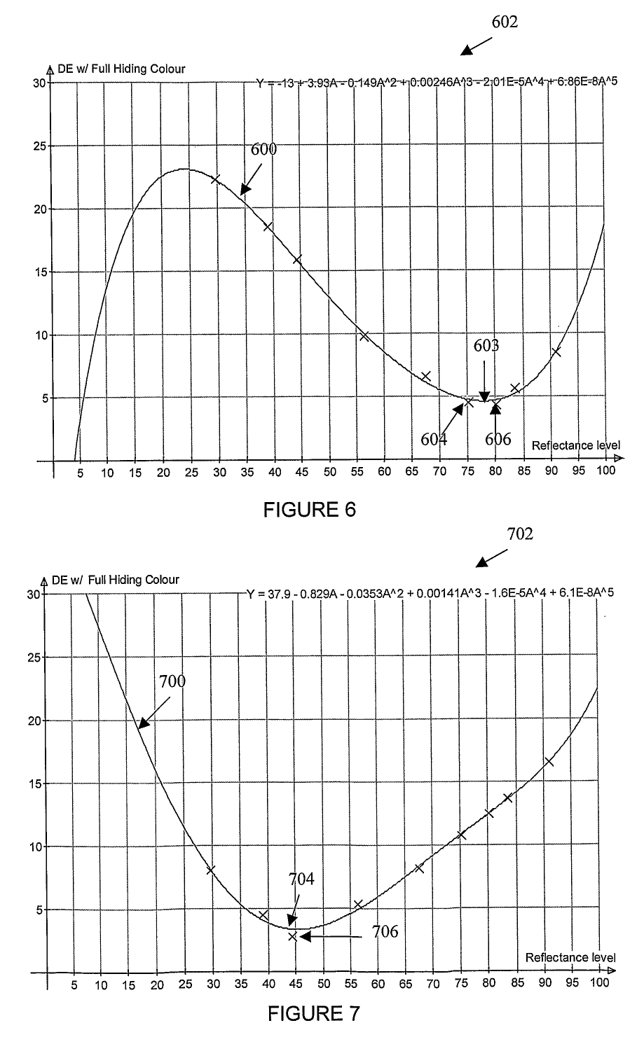

If no undercoat is selected at step 228, process 200 proceeds to 230. A correlation data generator component 122 of the module 110 performs step 230. At step 230, the color difference data for each topcoat/undercoat combination is retrieved from the database 112, and is then associated with the predetermined reflectance value for that tinted undercoat from the database 112. The reflectance of an undercoat is expressed as a percentage scale, where perfect black has a reflectance of 0% and perfect white has a reflectance of 100%. For example, an untinted base may have a reflectance value of less than 90%, whilst the maximum black tint would produce an undercoat with reflectance of about 30%. The color difference data and reflectance value for each undercoat is populated into a table (eg see Tables 1 and 2 below). The data in such a table can be represented as a graph display by the correlation data generator 122 to illustrate the correlation between the color difference data for each undercoat (eg the Delta-E value shown as the vertical axis in FIGS. 6 and 7) and the corresponding reflectance value for that undercoat (eg shown as the horizontal axis in FIGS. 6 and 7).

TABLE 1

| Reflectance | Color difference (in Delta-E units) of 2 coats of |
|---|---|
| of undercoat | topcoat (Pink Fire) applied over undercoat |
| “A” | “A”, and the topcoat full hiding color |
| 29.71 | 22.23 |
| 39.00 | 18.44 |
| 44.33 | 15.89 |
| 56.54 | 9.83 |
| 67.52 | 6.51 |
| 75.20 | 4.46 |
| 80.14 | 4.35 |
| 83.43 | 4.96 |
| 91.05 | 7.91 |

TABLE 2

| Reflectance | Color difference (in Delta-E units) of 2 coats of |
|---|---|
| of undercoat | topcoat (Scarlet Ribbons) applied over undercoat |
| “A” | “A”, and the topcoat full hiding color |
| 29.71 | 8.00 |
| 39.00 | 4.51 |
| 44.33 | 2.74 |
| 56.54 | 5.34 |
| 67.52 | 8.20 |
| 75.20 | 10.78 |
| 80.14 | 12.54 |
| 83.43 | 13.59 |
| 91.05 | 16.38 |

A selector component 124 of the module 110 selects the tinted undercoat that provides the least color difference (ie the lowest Delta-E value) when compared against the full hiding color of the topcoat, as the optimal undercoat. As such, the set of reflectance data corresponding to the optimal undercoat is retrieved from the database 112.

Alternatively, the selector 124 uses the data points on the chart generated based on the difference data and reflectance data for each undercoat (eg as shown in FIGS. 6 and 7) to generate a line of best fit. For example, the selector 124 can involve software such as Equation Grapher with Regression Analyzer, Version 3.2 (available from MFSoft International <http://www.mfsoft.com>) to generate a function that represents the line of best fit based on data values of the above described tables containing the difference data and reflectance data for different undercoats.

FIGS. 6 and 7 show displays generated by the selector 124 with lines of best fit 600 and 700 which are generated based on the data values in Tables 1 and 2 respectively. Data points in FIGS. 6 and 7 are shown as a cross. In FIG. 6, the function representing the line of best fit is a quintic (5th order) function 602, where variable A represents values from the horizontal axis and variable Y represents values from the vertical axis. Similarly, in FIG. 7, the function representing the line of best fit is also a quinery function 702, where variable A represents values from the horizontal axis and variable Y represents values from the vertical axis.

The line of best fit smooths out any irregular spikes in the data points, and provides the basis for identifying a more suitable undercoat with better reflectance properties. For example, the line of best fit in FIG. 6 shows a minima 603 between data points 604 and 606. This suggests that a tinted undercoat with a reflectance of around 77.5% is likely to produce a lower color difference than the tinted undercoats represented by data points 604 and 606. Based on the reflectance at the minima 603 and the base color of the undercoat, reflectance data can be generated for a new tinted undercoat (eg by generating a concentration value for a black colorant for inclusion into an undercoat base color, such as a white undercoat). The new tinted undercoat is then tested with the topcoat (as described above) to confirm any improvements in color difference. In FIG. 7, the minima 704 corresponds with the data point 706, and thus, the undercoat represented by data point 706 is selected by the selector 124 as the optimum undercoat for the respective topcoat. The minima should be selected within the range of reflectance values represent by actual data points, and should be proximate to the data points representing the lowest color difference. Alternatively, the undercoat corresponding to the data point closest to the minima 603 or 704 of the line of best fit is selected by the selector 124 as the optimum undercoat.

A background color generator component 126 of the module 110 performs steps 232, 236, 238, 240 and 242 of the process 200. At step 232 the process 200 generates a color difference value for the topcoat when applied to a surface without a tinted undercoat (DE_{W}). The color difference data value in step 232 is generated based on Equation 9, where reflectance data for the undercoat (represented by variable R_{G=U} in Equation 9) is substituted with the reflectance data for a typical surface (eg a set of reflectance data for a previously painted light colored surface with typical reflectance (eg reflectance of 85%). For greater accuracy, reflectance data derived from actual measurements of the surface on which the topcoat is applied is used, rather than using the reflectance data for a typical surface. The standard topcoat recommendation (usually 2 coats applied at a spreading rate of 16 m²/litre) is allowed for in the value of topcoat thickness (T) in Equation 9. The reflectance data (R) generated from Equation 9 in step 232, as described above, is used to determine the color of the topcoat/typical surface combination, and this is compared with the full hiding color of the topcoat (generated from R_{∞}) to generate the color difference value (DE_{W}) in Delta-E units.

At steps 236 and 240, the color difference value without a tinted undercoat (DE_{W}) is compared against a threshold color difference value (DE_{W=TOL}), being a tolerance threshold that is determined by market expectations as to the intended performance of the topcoat. To meet higher market expectations of topcoat opacity, a lower threshold color difference value (ie DE_{W=TOL}) is required. For example, the threshold color difference value (DE_{W=TOL}) based on 2 coats of topcoat typically falls within a range from 0.5 to 5.0.

If step 236 determines that the value of DE_{W} is less than the value of DE_{W=TOL}, then step 238 determines that the default opacity of the topcoat is acceptable, and there is no need to use a tinted undercoat. Otherwise, process 200 proceeds to step 240.

If step 240 determines that the value of DE_{W} is close to the value of DE_{W=TOL}, (e.g. within a tolerance range of two Delta-E units of the DE_{W=TOL} value) then step 242 determines whether additional coats of topcoat (eg up to a total of 3 or 4 coats) will bring the value of DE_{W} below the value of DE_{W=TOL} without requiring an undercoat. Otherwise, the topcoat is deduced as having a poor hiding color (suggesting that a tinted undercoat may provide a solution), and therefore process 200 proceeds to step 234.

For example, if the value of DE_{W} is close to the value of DE_{W=TOL}, then the value of DE_{W} can be brought closer to or less than the value of DE_{W=TOL} by applying further coats (eg an extra 1 or 2 coats) of topcoat without using a tinted undercoat. This can be confirmed by adjusting the film thickness variable (T) in Equation 9 to the value for 3 and 4 coats of topcoat, and recalculating the topcoat/undercoat reflectance values and the color difference DE_{W} as in Step 232. Table 3 below shows the effect of applying 1 to 4 coats of topcoat over a typical light colored surface of 85% reflectance.

TABLE 3

| | DE_{W} of | DE_{W} of |
|---|---|---|
| Number of Topcoats | “Pink Fire” | “Scarlet Ribbons” |
| 1 | 5.58 | 13.6 |
| 2 | 2.43 | 8.1 |
| 3 | 1.37 | 4.7 |
| 4 | 0.84 | 2.8 |

According to Table 3, if the DE_{W=TOL} value is set at 1.0, then applying two coats of Pink Fire topcoat yields of DE_{W} value of 2.43 (which is close to the DE_{W=TOL} value), and similarly, a DE_{W} value of 0.84 is achieved by applying 4 coats of Pink Fire without a tinted undercoat. In this example, the DE_{W} value for four coats of Pink Fire falls within the tolerance range of step 240, and thus, step 240 determines that applying four coats of Pink Fire topcoat will achieve satisfactory topcoat opacity. For Scarlet Ribbons, the DE_{W} value of 8.1 for two coats is not close to the DE_{W=TOL} value, and even four coats of topcoat (achieving a DE_{W} value of 2.8) will not achieve satisfactory topcoat opacity. Thus, step 240 proceeds to step 234.

An undercoat color difference generator component 128 of the module 110 performs steps 234, 244, 246, 248, 250 and 252. At step 234 the process generates a color difference value for the topcoat when applied to a surface with a tinted undercoat (DE_{U}). The color difference value in step 234 is generated based on Equation 9, where reflectance data for the optimal undercoat (represented by variable R_{G=U} in Equation 9) is used with the thickness (T) of a predetermined number of coats of topcoat (eg 2 coats of topcoat). The color calculated from the reflectance data (R), generated based on Equation 9 in step 234 as described above, is compared with the full hiding color of the topcoat (determined from R_{∞}) to generate the color difference value (DE_{U}) in Delta-E units.

At steps 244 and 248, the color difference value with an undercoat (DE_{U}) is compared against a threshold color difference value (DE_{U=TOL}), being a tolerance threshold that is determined by market expectations as to the intended performance of the topcoat. The threshold values DE_{W=TOL} and DE_{U=TOL} may have the same value. To meet higher market expectations of topcoat opacity, a lower threshold color difference value (ie DE_{U=TOL}) is required. For example, the threshold color difference value (DE_{U=TOL}) based on 2 coats of topcoat typically falls within a range from 0.5 to 5.0.

If step 244 determines that the value of DE_{U} is less than the value of DE_{U=TOL}, then step 246 determines that use of the selected undercoat successfully brings the topcoat color within the color specification. This is the case for Scarlet Ribbons in Table 4. Otherwise, process 200 proceeds to step 248.

If step 248 determines that the value of DE_{U} is close to the value of DE_{U=TOL} (eg within a tolerance range of two Delta-E unit of the DE_{W=TOL} value), then step 250 determines whether additional coats of topcoat will bring the value of DE_{U} below the value of DE_{W=TOL}.

For example, if the value of DE_{U} is close to the value of DE_{U=TOL}, the value of DE_{U} can be brought closer to or less than the value of DE_{U=TOL} by applying further coats (eg an extra 1 or 2 coats) of topcoat over the tinted undercoat. This can be confirmed by adjusting the film thickness variable (T) in Equation 9 to the value for 3 and 4 coats of topcoat, and recalculating the topcoat/undercoat reflectance values and the color difference DE_{U} as in Step 232. Table 4 below shows the effect of applying 1 to 4 coats of topcoat over the optimum undercoat for each color.

TABLE 4

| | DE_{U} | DE_{U} |
|---|---|---|
| Number of Topcoats | “Pink Fire” | “Scarlet Ribbons” |
| 1 | 4.50 | 2.74 |
| 2 | 1.10 | 0.95 |
| 3 | 0.53 | 0.79 |
| 4 | 0.38 | 0.58 |

According to Table 4, if the DE_{U=TOL} value is set at 1.0, then applying two coats of Pink Fire topcoat together with the optimum undercoat yields a DE_{U} value of 1.1 (which is close to but not less than the DE_{U=TOL} value), and similarly, a DE_{U} value of 0.53 is achieved with three coats of Pink Fire topcoat (together with the optimum undercoat). In this example, the DE_{U} value for three coats of Pink Fire topcoat (together with the optimum undercoat) falls within the tolerance range in step 248, and thus, step 250 determines that applying three coats of Pink Fire topcoat (together with the optimum undercoat) will achieve satisfactory topcoat opacity.

Otherwise, the undercoat is deduced as not being able to bring the topcoat color within the color specification even with the additional topcoat and process 200 proceeds to step 252. Step 252 determines whether additional coats of topcoat would be unable to achieve a satisfactory topcoat color, and if so, the topcoat is to be reformulated or deleted from the color range.

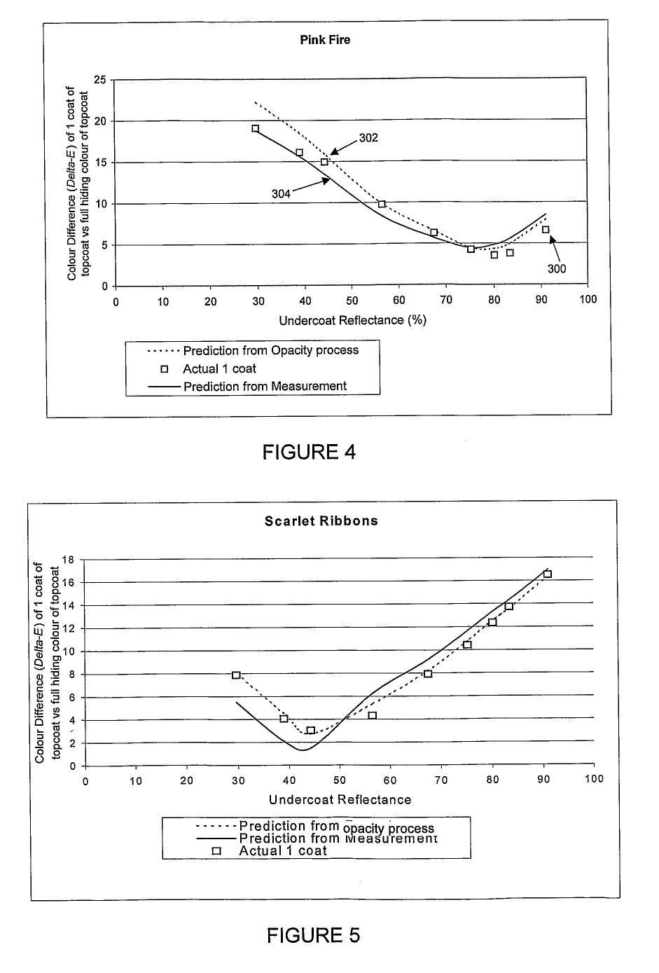

FIG. 4 shows a graph display generated using the system 106 showing the variations in color difference (or Delta-E) obtained between a single coat of topcoat (of the “Pink Fire” color) relative to its full hiding color, when the topcoat is used with different undercoats of different reflectance values. The color “Pink Fire” has a Munsell Notation of 9.5R 6.6/11.0, and is a medium chromatic orange. Each square dot point 300 represents the color difference determined from actual measurements of the reflectance value for each topcoat and undercoat combination. The different undercoats used have reflectance values ranging from 30% to 91%. The dotted line 302 represents the line of best fit for the predicted color differences (for each topcoat and undercoat combination), based on data generated, as described above, from the color formula of “Pink Fire” (steps 204 and following). The solid line 304 represents the line of best fit for the predicted color differences (for each topcoat and undercoat combination), based on reflectance measurements of the topcoat over contrasting substrates using the above method (steps 210 and following).

The three techniques, two predictive using procedures described herein, and one experimental, show satisfactory agreement on the optimum undercoat reflectance and the improvement in the color difference obtained through use of the tinted undercoat.

As shown by the square dot points 300, the measured reflectance values indicate a minimum of color difference when an undercoat with reflectance in the region of 80% is used. The predicted results, shown by lines 302 and 304, both indicate a minimum of color difference when an undercoat with reflectance of about 75% to 80% is used. Thus, the predicted values are in satisfactory agreement with the measured values.

From the graph in FIG. 4, when the single coat of topcoat is applied over a dark substrate of about 30% reflectance, a color difference (from the full hiding color) of about 20 Delta-E units is expected. Similarly, the graph in FIG. 4 indicates that the color difference can be reduced to less than 5 Delta-E units by using an undercoat with reflectance of about 80%. Thus, the number of coats of topcoat required to achieve a satisfactory final color is reduced by using a correcting undercoat of suitable reflectance.

If the same topcoat is applied to a white substrate of about 90% reflectance, then 1 coat of topcoat would produce a color difference of about 7 to 8 Delta-E units from the full hiding color. The optimum 80% undercoat reflectance would be better than 5 units, which is only a small improvement over the white substrate. For example, as shown in Tables 3 and 4, a color difference value for Pink Fire which is less than the threshold color difference value (ie DE_{W=TOL} or DE_{U=TOL}) of 1.0 can be achieved by applying 4 coats of Pink Fire over a light colored substrate (as shown in Table 3), or 3 coats of Pink Fire over the optimum undercoat (as shown in Table 4).

The display of FIG. 5 produced using the system 100 shows a graph showing the variations in color difference (or Delta-E) obtained between a single coat of topcoat (of the “Scarlet Ribbons” color) relative to its full hiding color, when the topcoat is used with undercoats of different reflectance. The color “Scarlet Ribbons”, of Munsell Notation 0.9R 3.7/11.5, is a dark chromatic blue-toned red.

When the topcoat is formulated using a clear base (eg as is the case for Scarlet Ribbons), the opacity is poor. With 1 coat applied to a dark substrate of reflectance 30%, the color difference is about 6 to 8 Delta-E units from the full hiding color. The same single coat applied to a white substrate would show a color difference of about 16 Delta-E units, which is unacceptable. Application of an undercoat of reflectance about 45% is indicated to reduce the color difference to better than 3 Delta-E units. For example, as shown in Tables 3 and 4, a color difference value for Scarlet Ribbons which is less than the threshold color difference value (ie DE_{W=TOL} or DE_{U=TOL}) of 1.0 cannot be achieved with 4 coats of Scarlet Ribbons over a light color substrate (as shown in Table 3), but can be achieved with 2 coats of Scarlet Ribbons over the optimum undercoat (as shown in Table 4).

Many modifications will be apparent to those skilled in the art without departing from the scope of the present invention as herein described with reference to the accompanying drawings. For example, the system 100 can be used with a variety of paint systems, such as automotive paint systems and decorative paint systems.

1. An opacity process for paint, including:
i) generating paint color data representing a paint color, based on the scatter and absorption data, or reflectance data, for said paint color;
ii) generating, based on said paint color data, full hiding color data representing the reflectance of said paint color at full hiding;
iii) generating, for a plurality of undercoat paints with different reflectance levels, color combination data representing the color of at least one coat of said paint color and one of said undercoat paints, respectively; and
iv) generating color difference data representing opacity, based on a difference between said full hiding color data and said color data combination.

2. A process as claimed in claim 1, including generating correlation data representing the correlation between the values of said color difference data and the reflectance levels of said undercoat paints.

3. A process as claimed in claim 2, including selecting, based on said correlation data, an undercoat paint having a reflectance level corresponding to a least color difference represented by said color difference data.

4. A process as claimed in claim 1, including
generating background color data representing the reflectance level of the background color over which said paint color is to be applied; and
generating a background color difference data value representing color difference between the color represented by said full hiding color data and the background color represented by said background color data.

5. A process as claimed in claim 4, wherein if said background color difference data value is within one Delta-E unit of a background color threshold value, determining the additional coats of said paint color necessary to achieve satisfactory opacity of said paint color without applying said undercoat paint.

6. A process as claimed in claim 5, wherein if said background color difference data value is otherwise less than said background color threshold value, determining that the opacity of said paint color is satisfactory without applying additional coats of said paint color or said undercoat paint.

7. A process as claimed in claim 5, wherein said background color threshold value ranges from 0.5 to 5 Delta-E units, inclusive.

8. A process as claimed in claim 1, including generating, based on said full hiding color data and said color combination data, undercoat color difference data representing a combination of at least one coat of said paint color and a selected one of said undercoat paints.

9. A process as claimed in claim 8, wherein if said undercoat color difference value is within one Delta-E unit of an undercoat color threshold value, determining the additional coats of said undercoat paint necessary to achieve satisfactory opacity of said paint color.

10. A process as claimed in claim 9, wherein if said undercoat color difference value is otherwise less than said undercoat color threshold value, determining that satisfactory opacity of said paint color is achieved using said undercoat paint.

11. A process as claimed in claim 11, wherein said undercoat color threshold value ranges from 0.5 to 5 Delta-E units, inclusive.

12. An opacity system for paint, including:
i) a paint color generator for generating paint color data representing a paint color, based on the scatter and absorption data, or reflectance data, for said paint color;
ii) a full hiding color generator for generating, based on said paint color data, full hiding color data representing the reflectance of said paint color at full hiding;
iii) a color combination generator for generating, for a plurality of undercoat paints with different reflectance levels, color combination data representing the color of at least one coat of said paint color and one of said undercoat paints, respectively; and
iv) a color difference generator for generating color difference data representing opacity, based on a difference between said full hiding color data and said color combination data.

13. A system as claimed in claim 12, including a correlation data generator for generating correlation data representing the correlation between the values of said color difference data and the reflectance levels of said undercoat paints.

14. A system as claimed in claim 13, including a selector for selecting, based on said correlation data, an undercoat paint having a reflectance level corresponding to a least color difference represented by said color difference data.

15. A system as claimed in claim 12, including a background color generator for:
generating background color data representing the reflectance level of the background color over which said paint color is to be applied; and
generating a background color difference data value representing color difference between the color represented by said full hiding color data and the background color represented by said background color data.

16. A system as claimed in claim 15, wherein if said background color difference data value is within one Delta-E unit of a background color threshold value, said background color generator determines the additional coats of said paint color necessary to achieve satisfactory opacity of said paint color without applying said undercoat paint.

17. A system as claimed in claim 16, wherein if said background color difference data value is otherwise less than said background color threshold value, said background color generator determines that the opacity of said paint color is satisfactory without applying additional coats of said paint color or said undercoat paint.

18. A system as claimed in claim 16, wherein said background color threshold value ranges from 0.5 to 5 Delta-E units, inclusive.

19. A system as claimed in claim 12, including an undercoat color difference generator for generating, based on said full hiding color data and said color combination data, undercoat color difference data representing a combination of at least one coat of said paint color and a selected one of said undercoat paints.

20. A system as claimed in claim 19, wherein if said undercoat color difference value is within one Delta-E unit of an undercoat color threshold value, said undercoat color difference generator determines the additional coats of said undercoat paint necessary to achieve satisfactory opacity of said paint color.

21. A system as claimed in claim 20, wherein if said undercoat color difference value is otherwise less than said undercoat color threshold value, said undercoat color difference generator determines that satisfactory opacity of said paint color is achieved using said undercoat paint.

22. A system as claimed in claim 20, wherein said undercoat color threshold value ranges from 0.5 to 5 Delta-E units, inclusive.

23. A computer readable medium including a computer program code for performing an opacity process for paint, wherein the process comprises:
generating paint color data representing a paint color, based on the scatter and absorption data, or reflectance data, for said paint color;
generating, based on said paint color data, full hiding color data representing the reflectance of said paint color at full hiding;
generating, for a plurality of undercoat paints with different reflectance levels, color combination data representing the color of at least one coat of said paint color and one of said undercoat paints, respectively; and
generating color difference data representing opacity, based on a difference between said full hiding color data and said color data combination.
